(19) United States
(12) Patent Application Publication
(10) Pub. No.: US 2008/0255794 A1
(43) Pub. Date: Oct. 16, 2008

(54) PHYSICAL ACTIVITY MONITORING AND PROMPTING SYSTEM

(76) Inventor: James A. Levine, Oronoco, MN (US)

Correspondence Address: WESTMAN CHAMPLIN & KELLY, P.A., SUITE 1400, 900 SECOND AVENUE SOUTH, MINNEAPOLIS, MN, 55402-3244, US

(21) Appl. No.: 11/870,990

(22) Filed: Oct. 11, 2007

Related U.S. Application Data
(60) Provisional application No. 60/850,998, filed on Oct. 11, 2006.
(60) Provisional application No. 60/859,623, filed on Nov. 17, 2006.

(51) Int. Cl. G01P 15/00

(52) U.S. Cl. 702/141

(57) ABSTRACT

An apparatus and method are provided in various illustrative embodiments for monitoring a user's physical activity and prompting a user to undertake physical activity as needed. An illustrative embodiment includes a wearable activity sensor, an output device, and a control system. The control system is configured to receive data from the activity sensor and provide output via the output device as a function of the data from the activity sensor. The output comprises content associated with utilizing an exercise enabling device.

### CROSS-REFERENCE TO RELATED APPLICATIONS

The present application claims the benefit of priority under 35 U.S.C. 119(e) to, and incorporates by reference, both U.S. provisional application 60/850,998, filed Oct. 11, 2006, and U.S. provisional application 60/859,623, filed Nov. 17, 2006.

### BACKGROUND

The traditional office work environment involves a person being seated at a desk for much of the workday. A typical personal work environment in a modern office is centered around a horizontal desk at sitting height, on which a computer, computer screen, keyboard, mouse, pens, papers, phone, and other paraphernalia may be disposed. The user sits at a chair that is placed in front of the desk. The drawback of this approach to working is that the user tends to remain sedentary throughout much of the day, day after day for very long periods of time. Such long-term, persistent sedentariness is strongly associated with weight gain and obesity, which in turn is associated with diminished quality of life, increased risk factors for many major diseases, ill health, and high health costs. An ever-increasing proportion of the modem work force throughout much of the world are being put into such sedentary work conditions.

The discussion above is merely provided for general background information and is not intended to be used as an aid in determining the scope of the claimed subject matter.

### SUMMARY

A system is hereby provided that detects a person's inactivity whilst working and prompts the person to be physically active. An apparatus and method are provided in various illustrative embodiments for monitoring a user's physical activity and prompting a user to undertake physical activity as needed. An illustrative embodiment includes a wearable activity sensor, an output device, and a control system. The control system is configured to receive data from the activity sensor and provide output via the output device as a function of the data from the activity sensor. The output comprises content associated with utilizing an exercise enabling device.

This Summary is provided to introduce a selection of concepts in a simplified form that are farther described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 depicts a physical activity monitoring and prompting system in an illustrative context of usage, according to an illustrative embodiment.

FIG. 2 depicts a physical activity monitoring and prompting system, according to another illustrative embodiment.

FIG. 3 depicts part of a physical activity monitoring and prompting system, according to another illustrative embodiment.

FIG. 4 depicts part of a physical activity monitoring and prompting system, according to another illustrative embodiment.

FIG. 5 depicts part of a physical activity monitoring and prompting system, according to another illustrative embodiment.

FIG. 6 depicts a physical activity sensor, according to another illustrative embodiment.

FIG. 7 depicts a physical activity sensor, according to another illustrative embodiment.

FIG. 8 depicts a physical activity sensor, according to another illustrative embodiment.

FIG. 9 depicts a flowchart for a method of a physical activity monitoring and prompting system, according to another illustrative embodiment.

### DETAILED DESCRIPTION OF ILLUSTRATIVE EMBODIMENTS

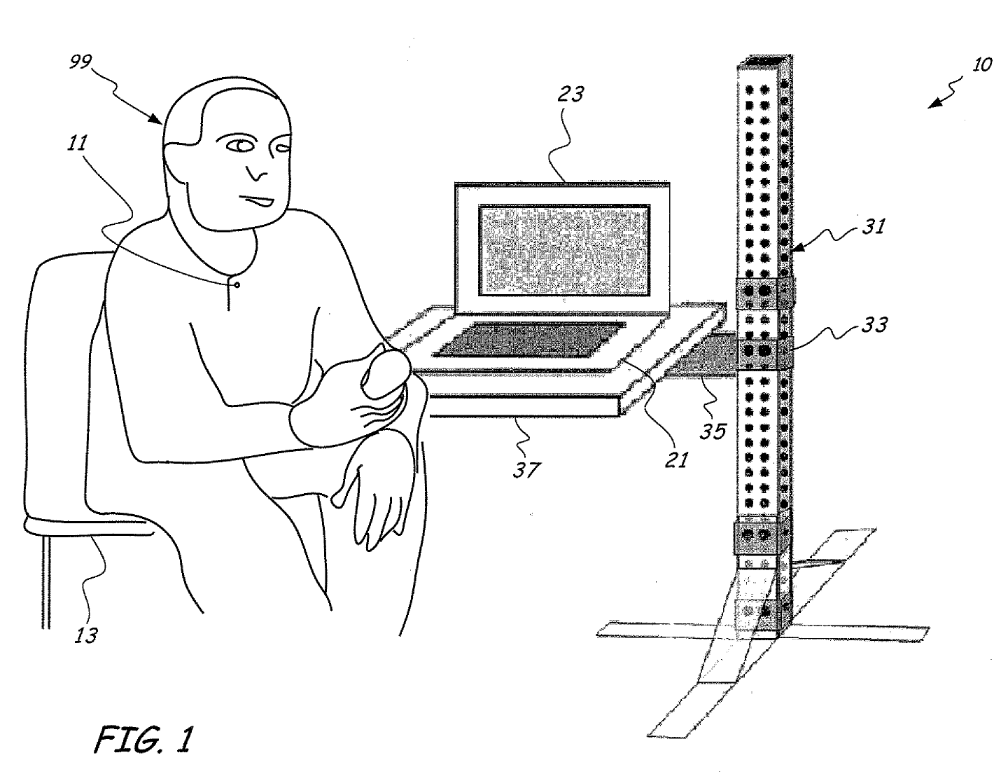

FIG. 1 depicts a system 10 for monitoring and prompting the physical activity of a user 99 in an illustrative context of usage, according to an illustrative embodiment. In this context of usage, user 99 is seated in chair 13 while engaging in a typical office work situation of sitting and working at a computer. System 10 is enabled to detect and prompt the user 99 when user 99 is sedentary for a persistent length of time, and to provide the physical structures to enable the user to respond to the prompt by engaging in light exercise or other activity while continuing to perform work with computer 21 or with other office work implements.

System 10 includes wearable activity sensor 11, computer 21, and monitor 23, in this illustrative embodiment. Activity sensor 11 is integrated into a button sewn into the user's shirt, in this example. Activity sensor 11 may illustratively include an accelerometer and a transmitter. System 10 may then measure the accelerations detected by the accelerometer and analyze them over time. The analysis of the accelerations may be done by hardware that is also integrated into activity sensor 11, or may be done by an outside component, such as computer 21 executing a program configured to manage the activity sensor 11. Either way, the transmitter of activity sensor 11 may transmit data from activity sensor 11 to computer 21, where that data may be either a raw signal from the accelerometer to be processed or analyzed by computer 21, or data that has already undergone some degree of processing or analysis by the sensor 11's own hardware. Computer 21 may be enabled to receive such data by means of attachment with a specialized device for receiving wireless transmissions from sensor 11, or with a general-purpose wireless receiver such as may also be used for wireless network or Internet access, for example. Such wireless transmissions may take the form of any protocol or transmission type known to those in the art.

Activity sensor 11 is depicted integrated with a shirt button in the illustrative embodiment of FIG. 1, but may take any form in other embodiments that allow it to generally measure the physical activity of the user 99. For example, activity sensor 11 may be sewn into an article of clothing worn by the user, or attached directly to the user's body such as in the form of a strapped device or a skin patch, for example. Different embodiments of the activity sensor may include any of a number of different components to allow it to sense the user's physical activity such as an accelerometer, a compression sensor, or any other mechanism to evaluate a user's physical activity, and one or more sensors of one or more types may be used together to broaden the amount and accuracy of information on the user's physical activity. The activity sensor may be composed on a very small scale such as microscopic or nanoscopic, to remain as unobtrusive and lightweight as possible. Additional description of exemplary options for the activity sensor are provided with reference to additional figures, described below.

Computer 21 may thereby serve as a control system for physical activity monitoring and prompting system 10, in executing a software package directed to such a system. This physical activity monitoring and prompting software may of course be running simultaneously with many other routine and work-related applications running on computer 21. The physical activity monitoring and prompting software may also include executable, database, or other components distributed among one or more additional computing nodes in communicative contact with computer 21, such as computing elements accessible in a scaled area network (e.g. personal area network or large area network) or accessible via the Internet, for example.

Computer 21 is also operatively connected to monitor 23 in the illustrative example of FIG. 1, and may display a variety of routine and work-related output related to other applications, while also displaying information related to the physical activity monitoring and prompting system 10. Monitor 23 thereby may serve as an output device as part of system 10, at the same time that it may also provide other outputs. For example, messages related to system 10 to prompt the user 99 regarding his physical activity may be provided as pop-up windows or a varying system tray icon on monitor 23, for example. System 10 may make use of other output device, such as audio speakers associated with computer 21 or monitor 23, or other specialized video and/or audio output devices, for example.

Computer 21 thereby acts as a control system that is configured to receive data from the activity sensor 11 and provide output via the monitor 23 as a function of the data from the activity sensor. This output may include content associated with utilizing an exercise enabling device. Such an exercise enabling device is not depicted in FIG. 1, but examples are depicted in later figures, described below. Such an exercise enabling device may be a treadmill, a stair stepping device, a low-friction plate, or other device that enables the user to perform exercise while continuing to perform other tasks. Computer 21 thereby serves as a control system that provides output via monitor 23 in response to data from the activity sensor 11 that indicates a low level of physical activity by user 99 for a given length of time.

The content associated with using such an exercise enabling device may include a prompting to the user recommending that the user now take some time to exercise. The content may also include, for example, an indication of how long the user has been relatively physically inactive, a recommendation on how long the user should engage in exercise, or an indication of incentives or rewards for engaging in exercise, for example. Once the user has begun exercising, such content may also include information on how much time the user has so far spent exercising, information related to the effectiveness of the exercise such as calories being consumed, and a recommended remaining length of time to persist in performing the exercise, for example.

System 10 may include physical structures that facilitate engaging in such exercise while continuing uninterrupted in performing the user's typical work, so that the exercise does not compete with the user's workday, but instead remains compatible with accomplishing the user's work. The physical structures associated with system 10 in the illustrative embodiment of FIG. 1 include vertical support body 31, adjustable clamp 33 fixed to vertical support body 31, desk support beam 35 attached to adjustable clamp 33, and adjustable desk work surface 37 mounted on desk support beam 35. Computer 21 and monitor 23 are disposed on adjustable desk work surface 37, in this illustrative embodiment. Adjustable clamp 33 may be enabled to be loosened, vertically adjusted, and re-fastened, either manually or automatically as directed by system software running on computer 21 or other control system, to cause the work surface 37 to be adjusted in height to accommodate user 99 while he is either sitting or standing. Being set to an appropriate height for the user while standing also provides compatibility with the user utilizing a treadmill, a stair stepping device, or other such exercise enabling device, while performing his work, in this illustrative embodiment.

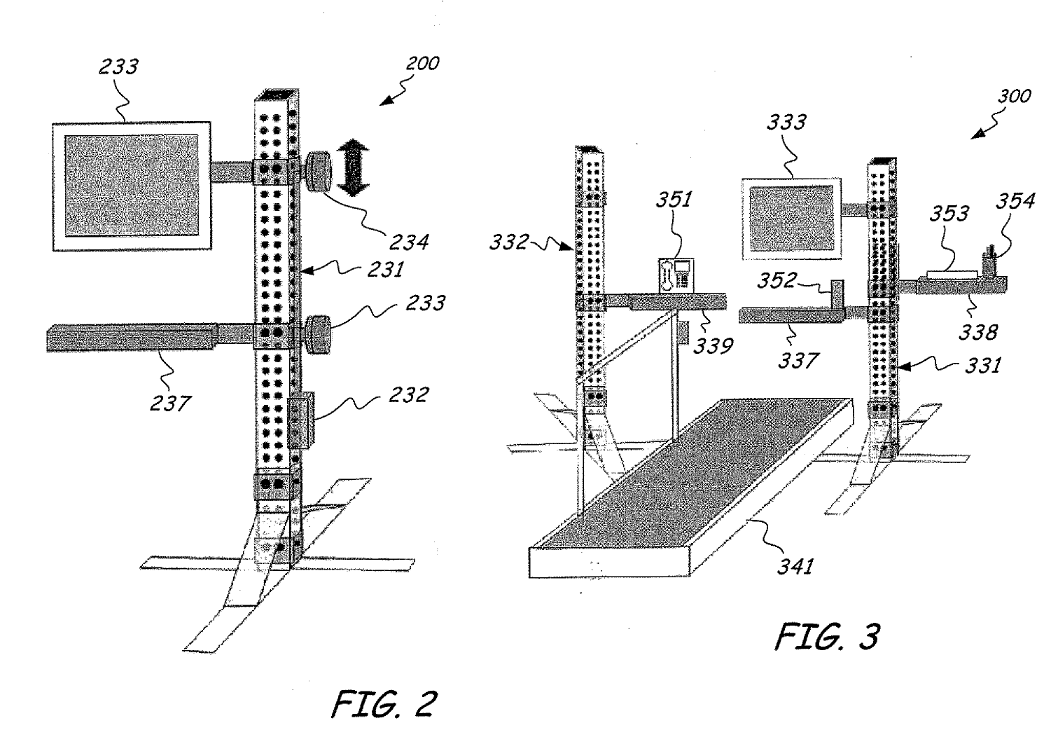

FIG. 2 depicts a physical activity monitoring and prompting system 200, according to another illustrative embodiment. System 200 may also include a wearable activity sensor (not depicted in FIG. 2), as well as monitor 233, which is adjustably mounted by means of adjustable clamp 234 on vertical support body 231. System 200 also includes adjustable clamp 233 which holds fastened adjustable desk work surface 237, on which a computer, keyboard, or other work implement may be disposed. The adjustable heights of work surface 237 and monitor 233 facilitate the user switching between a sitting or standing position while continuing to perform his routine work. System 200 may also include control box 232, which may serve as an independent control system for the system to receive data from the activity sensor, to provide output to the user via monitor 233 or other output means, and to automatically adjust clamps 233 and 234 to adjust the height of the work surface 237 and the monitor 233 to a height consistent with standing position while the user is to engage in exercise.

FIG. 3 depicts part of a physical activity monitoring and prompting system 300, according to another illustrative embodiment. System 300 includes two separate vertical support bodies 331, 332, as well as treadmill 341 disposed proximate to the vertical support bodies. Treadmill 341 may serve as an exercise enabling device, and the user may walk or jog on treadmill 341 while performing routine work using work implements supported by the vertical support bodies 331, 332. Such implements include telephone 351, mobile computing device 352, monitor 333, papers 353, and writing utensils 354, which are supported on desk work surfaces 339, 337, and 338 respectively, which in turn are adjustably mounted on vertical support bodies 332, 331 respectively. These vertical support bodies, desk work surfaces, and work implements therefore constitute a workstation to which treadmill 341, as an illustrative example of an exercise enabling device, is proximately disposed. The control system for the system 300 may include software running on mobile computing device 352, for example, or may include other components not depicted in FIG. 3. The treadmill 341 may be capable of a variety of speed settings, and may incorporate optional, power-saving features such as a pulsed, intermittent motor, or low inertia roller to allow it to facilitate it to be driven in part by the momentum of the user's footsteps, for example.

The desk work surfaces 339, 337, 338 may be at a fixed height or an adjustable height, and the adjustable height may be adjustable either manually or automatically. In an illustrative example, system 300 may be configured to automatically adjust the height at which any of the work surfaces 339, 337, 338 are suspended from the vertical support bodies 332, 331, as a function of the content associated with utilizing the exercise enabling device comprised in the output of the control system. For example, the control system may automatically raise the height of the work surfaces when it prompts the user to engage in exercise, or it may include a one-touch option for the user to engage to raise the height of the several work surfaces to the user's pre-selected standing height and perform other adjustments automatically to facilitate the user's seamlessly beginning to exercise without interrupting the simultaneous flow of his work. In this context, a “one-touch” option may include either a literal single touch of a key or softkey on a monitor, or may colloquially refer to any other simplified input to engage pre-selected adjustments for facilitating a seamless transition into performing exercise simultaneously with continuing to work.

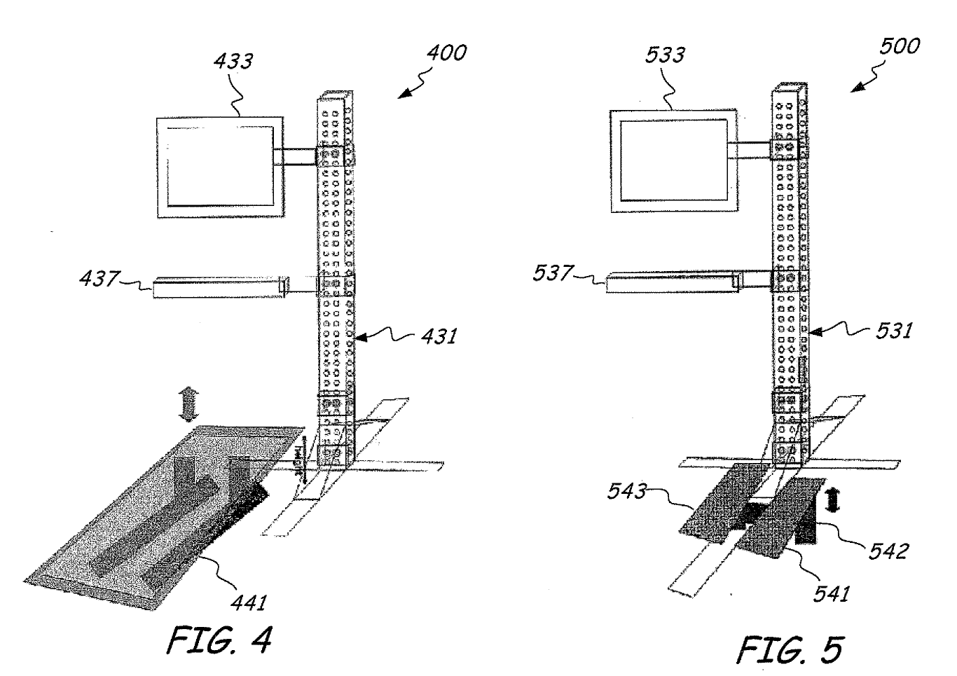

FIG. 4 depicts part of a physical activity monitoring and prompting system 400, according to another illustrative embodiment. System 400 also includes a vertical support body 431, with a work surface 437 and monitor 433 mounted to it at adjustable heights. System 400 further includes a low-friction plate 441 disposed proximate to the workstation centered on vertical support body 431. Low-friction plate 441 is set at an angle and serves as another illustrative example of an exercise enabling device, and may function as a low-tech treadmill, where the user dons low-friction slippers so that she can engage in a walking motion on the low-friction plate and rely on the tilt angle of the plate and the low-friction interface to allow her feet to slide controllably backward and allow her to engage in a continuous walking motion while remaining in place at the workstation centered on vertical support body 431. For example, the low-friction plate may be composed of smooth plastic or aluminum, while the low-friction footwear used with it may include fabric-soled slippers, in an illustrative embodiment.

FIG. 5 depicts part of a physical activity monitoring and prompting system 500, according to another illustrative embodiment. System 500 also includes a vertical support body 531, with a work surface 537 and monitor 533 mounted to it at adjustable heights. System 500 further includes a stair stepping device with reflexive stair steps 541, 543 that are supported by mechanical means 542 that continuously raise the steps 541, 543 back to a raised height whenever the user takes her weight off of them. Mechanical means 542 may include hydraulic, electrical, or other means for raising the steps back to their raised height. The user may therefore continuously walk in place on reflexive stair steps 541, 543 and engage in the exercise of mimicking walking up an endless flight of stairs, while remaining at the workstation centered around vertical support body 531.

Any of the exercise enabling devices depicted in these figures, or other examples, may also be configured to provide data related to its utilization. The control system may also be further configured to receive the data from the exercise enabling device and to provide output as a function of the data from the exercise enabling device. For example, the output may include an indication of a recommended remaining time left to utilize the exercise enabling device, a length of time elapsed while utilizing the exercise enabling device, an amount of calories expended utilizing the exercise enabling device, or a grant of credit that may be redeemed for an incentive, for example.

The credit and incentive may be involved in an incentive system used in association with the physical activity monitoring and prompting system, whereby certain amounts of exercise per day or other unit time are assigned certain amounts of credits or points toward earnable incentives, such as discounts or free grants of items of food, clothing, movie tickets, or other rewards. Such an incentive system may be sponsored by a subscription by the user herself, or by the user's employer or health care organization or health insurance provider, for example.

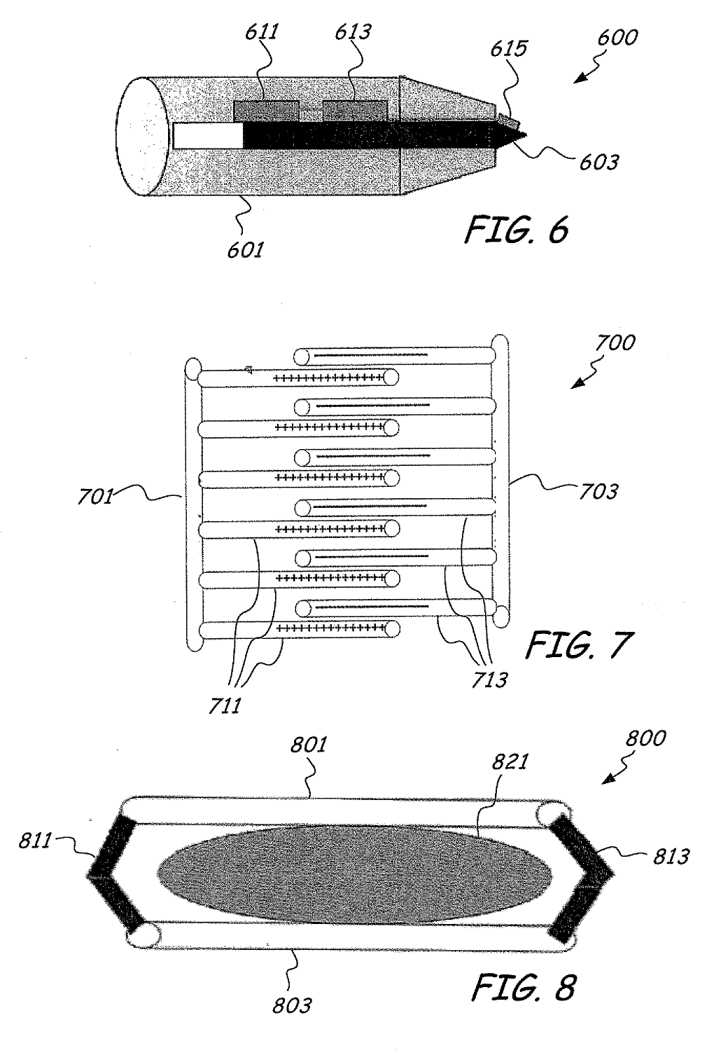

FIG. 6 depicts a physical activity sensor 600, according to another illustrative embodiment in which physical activity sensor 600 is integrated in a pen. The pen includes a typical pen shaft 601 and writing tip 603, as well as an accelerometer 613 and a transmitter 615 for providing the data from the accelerometer 613 to the control system (not depicted in this figure). Pen sensor 600 may also include a gyroscope 611, which further measures the motions of the pen and provides such further data to transmitter 615. Pen sensor 600 may therefore provide data of higher quality on the motions of the wearer, and may also provide data of sufficient quality to reproduce the writing being done with the pen, so that it may double as a user input device, transmitting written motions directly into computer inputs.

A physical activity sensor may also include an inclinometer, which measures the angle relative to gravity, which may also provide additional information on the physical motions of the user. The sensor may then provide data on the angle relative to gravity along with data on physical activity to the control system, which may provide further useful information about the physical activity of the user, as well as about the user's posture.

FIG. 7 depicts a physical activity sensor 700, according to another illustrative embodiment. Sensor 700 may be nanoscopic in scale, and may be embedded into the clothing or another wearable item borne by a user. Sensor 700 includes electrical busses 701, 703 which support positively and negatively charged tubes or dendrites 711, 713 respectively. Motions of the dendrites 711, 713 backward and forward relative to each other cause corresponding changes in the capacitance or voltage of the dendrites 711, 713, which may induce signals such as alternating currents in electrical busses 701, 703 that are transmitted to a sensor core and conveyed in the transmissions of the sensor to the control system. Sensor 700 is therefore configured to translate physical motions into changes in an electrical variable, in this illustrative embodiment.

FIG. 8 depicts a physical activity sensor 800, according to another illustrative embodiment. Sensor 800 is sensitive to compression. Sensor 800 includes opposing plates 801, 803 that are connected by flexible joints 811, 813 and separated by compressible gel 821, the combination of which renders the distance between plates 801, 803 a sensitive measure of the compression force acting on the plates 801, 803. Sensor 800 may be embedded in an article of clothing worn by a user at a position that is liable to be compressed as long as the user remains seated, such that the sensor 800 is able to convey a signal transmitting information on the length of time the user remains seated. A physical activity monitoring and prompting system including sensor 800 may therefore compare the signal from sensor 800 with a determined length of time, and if the length of time the user remains seated surpasses a threshold length of time for the user, the system may then prompt the user to stand up and engage in physical exercise.

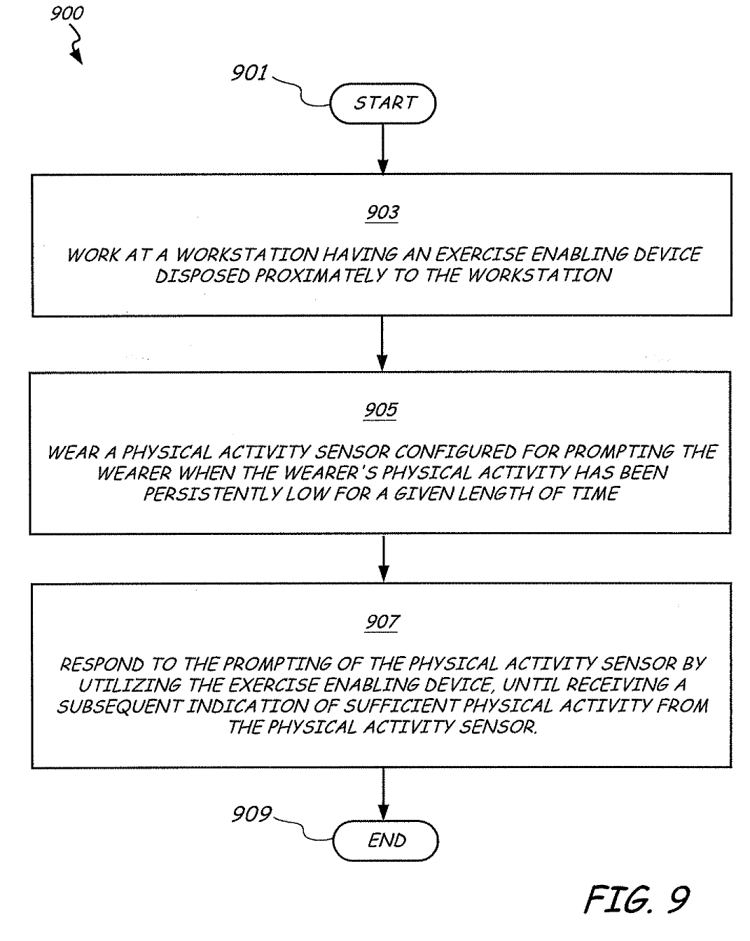

FIG. 9 depicts a flowchart for a method of a physical activity monitoring and prompting system, according to another illustrative embodiment. Method 900 begins at step 901 and includes step 903, of working at a workstation having an exercise enabling device disposed proximately to the workstation; step 905, of wearing a physical activity sensor configured for prompting the wearer when the wearer's physical activity has been persistently low for a given length of time; and step 907, of responding to the prompting of the physical activity sensor by utilizing the exercise enabling device, until receiving a subsequent indication of sufficient physical activity from the physical activity sensor.

Additional health-related information on the user may also be sensed by various features of a physical activity sensor and relayed to the control system, such as heart rate, blood pressure, metabolic rate, pulse, respiration, stress, blood glucose level, and other factors. The control system may vary in the sophistication of its algorithms for determining when to prompt the user to exercise and how long to recommend that the user exercise, from very simple, pre-selected values, to more sophisticated software that continuously or periodically evaluates new inputs regarding any of a wide array of health variables, including those being transmitted at the time by one or more sensors, and values about the user's physical status that are previously entered or are retrieved from other data sources. For example, the control system may revise its recommended duration or intensity of exercise upward or downward based on the user's heart-rate being lower or higher, respectively, than had earlier been predicted by the control system's algorithms. As another example, for a user who is diabetic and insulin-dependent, the control system may factor in exercise that it detects the user performing titrate an insulin dose downward for glucose sensing and insulin delivery features driven a diabetes management application in communicative connection with the physical activity sensing and monitoring application.

Various embodiments of the physical activity sensing and monitoring system may also provide substantial savings in cost of physical workspace furniture and in square footage of office space when compared with a comparable, traditional office workspace setting.

Of far greater anticipated value, however, are the dramatic savings in healthcare costs and similarly dramatic rise in quality of life for users who are enabled to achieve a healthier weight, lower rates of risk factors associated with a persistently sedentary lifestyle such as back pain, hypertension, hypercholesterolemia, and diabetes, and better health overall by seamlessly incorporated a greater amount of physical exercise into an otherwise sedentary occupational setting.

Although the present disclosure has been described with reference to one or more embodiments, workers skilled in the art will recognize that changes may be made in form and detail without departing from the disclosure or the appended claims. Many other variations among different embodiments may also be made within the metes and bounds of the subject matter described by the present disclosure and defined by the claims recited below.

What is claimed is:

1. An apparatus comprising:
a wearable activity sensor;
an output device; and
a control system configured to receive data from the activity sensor and provide output via the output device as a function of the data from the activity sensor, wherein the output comprises content associated with utilizing an exercise enabling device.

2. The apparatus of claim 1, wherein the control system provides the output via the output device in response to data from the activity sensor that indicates a low level of physical activity by a wearer of the activity sensor for a length of time.

3. The apparatus of claim 1, further comprising an exercise enabling device.

4. The apparatus of claim 3, further comprising a workstation comprising at least one substantially vertical support body and at least one work surface suspended from the support body, wherein the exercise enabling device is disposed proximately to the workstation.

5. The apparatus of claim 4, further configured to automatically adjust a height at which the work surface is suspended from the vertical support body, as a function of the content associated with utilizing the exercise enabling device comprised in the output of the control system.

6. The apparatus of claim 3, wherein the content associated with utilizing the exercise enabling device comprised in the output of the control system comprises one or more user-perceptible promptings to utilize the exercise enabling device.

7. The apparatus of claim 3, wherein the exercise enabling device is further configured to provide data related to its utilization, and the control system is further configured to receive the data from the exercise enabling device and to provide output as a function of the data from the exercise enabling device.

8. The apparatus of claim 7, wherein the output comprises an indication of remaining time left to utilize the exercise enabling device.

9. The apparatus of claim 7, wherein the output comprises a grant of credit that may be redeemed for an incentive.

10. The apparatus of claim 3, wherein the exercise enabling device comprises at least one of a treadmill, a stair stepping device, or a low-friction plate.

11 The apparatus of claim 1, wherein the wearable activity sensor comprises an accelerometer configured to be attached to a wearer's body.

12. The apparatus of claim 1, wherein the wearable activity sensor comprises an accelerometer integrated into a wearable article of clothing.

13. The apparatus of claim 1, wherein the wearable activity sensor comprises electrically charged tubes disposed adjacent to each other and configured to translate physical motions into changes in an electrical variable.

14. The apparatus of claim 1, wherein the wearable activity sensor is further configured to detect an angle relative to gravity, and to provide data on the angle relative to gravity along with data on physical activity to the control system.

15. The apparatus of claim 1, wherein the wearable activity sensor comprises a compression-sensitive sensor.

16. The apparatus of claim 1, wherein the wearable activity sensor comprises a pen comprising an accelerometer.

17. The apparatus of claim 1, wherein the wearable activity sensor comprises a data output device configured to provide wireless transmissions.

18. An apparatus comprising:
a workstation comprising a vertical support body and a work surface suspended from the support body;
a means for enabling exercise disposed proximately to the workstation;
a wearable activity sensor;
an output device; and
a control system configured to:
receive data from the activity sensor that indicates levels of physical activity of the wearer over time;
respond to persistently low levels of physical activity of the wearer by providing one or more promptings via the output device to utilize the means for enabling exercise; and
respond to levels of physical activity consistent with exercise by providing indications via the output device on remaining time to spend exercising and by providing incentives for time spent exercising.

19. The apparatus of claim 18, wherein the means for enabling exercise comprises at least one of a treadmill, a stair stepper, or a low-friction plate.

20. A method comprising:
working at a workstation having an exercise enabling device disposed proximately to the workstation;
wearing a physical activity sensor configured for prompting the wearer when the wearer's physical activity has been persistently low for a given length of time;
responding to the prompting of the physical activity sensor by utilizing the exercise enabling device, until receiving a subsequent indication of sufficient physical activity from the physical activity sensor.
